(19) United States
(12) Patent Application Publication
(10) Pub. No.: US 2011/0122144 A1
(43) Pub. Date: May 26, 2011

(54) Automatically Adaptive Display Eliminating Need For Vision Correction Aids

(76) Inventor: Ofer Gabay, Herzelia (IL)

(21) Appl. No.: 12/624,909

(22) Filed: Nov. 24, 2009

(51) Int. Cl. G09G 5/02

(52) U.S. Cl. 345/589

(57) ABSTRACT

A data processing system for overcoming at least one vision impairment of a user, comprising a control unit connected to a display, wherein the control unit is arranged to distort a images in relation to the vision impairment and predefined criteria, and to display the distorted images on the display, such that the user suffering from the vision impairment perceives the distorted images as a healthy user perceives the original images. The distortion is continuously and dynamically adjusted in relation to spatial and temporal dimensions of the original images and of objects therein. Vision impairments compensated for may comprise astigmatism; myopia; hyperopia; presbyopia; and color blindness. The display may comprise a watch, a mobile device display, a phone handset, a screen of any type, a transparent material, such as a window, or a reflecting material such as a mirror.

### BACKGROUND

1. Technical Field

The present invention relates to the field of image processing, and more particularly, to processing images in relation to vision impairment.

2. Discussion of Related Art

Displays are very common in daily life, as are also vision impairments. Usually visual aids such as eye glasses are applied for routine compensation of vision impairments, yet using displays and image processing opens new possibilities for practical compensation of vision impairments.

### BRIEF SUMMARY

Embodiments of the present invention provide a data processing system for overcoming at least one vision impairment of a user, comprising a control unit connected to a 2D or 3D display, wherein the control unit is arranged to distort a plurality of original real-time images or a video stream in relation to the at least one vision impairment and predefined criteria, and to display the distorted images (or video) on the display, such that the user suffering from the at least one vision impairment perceives the distorted images or video as a healthy user perceives the original images.

Accordingly, according to an aspect of the present invention, there is provided a data processing system, wherein the distortion is continuously and dynamically adjusted in relation to spatial and temporal dimensions of the original images and of objects therein.

Accordingly, according to another aspect of the present invention, there is provided a data processing system, wherein the vision impairment comprises any of: astigmatism; myopia; hyperopia; presbyopia; and color blindness, and the control unit is arranged to compensate for user perceived blurring of objects in the original images due to these vision impairments.

Accordingly, according to still another aspect of the present invention, there is provided a data processing system, wherein the display comprises any of: a watch, a mobile device display, a cordless phone display, a screen of any type (e.g., a computer display, a monitor, a TV screen), a transparent material, such as a window, or associated therewith (for example, a vehicle window, wherein the data processing system extends a field of view of the user driving the car), or with a reflecting material such as a minor.

Accordingly, according to yet another aspect of the present invention, there is provided a data processing system, further comprising a feedback module arranged to present the user with a plurality of predefined calibration images and receive from the user input relating to the perceived clarity of the predefined calibration images, wherein the feedback module is arranged to calculate at least one distortion parameter from user input and adjust the distortion applied by the control unit to the original images accordingly.

Accordingly, according to another aspect of the present invention, there is provided a data processing system, further comprising a calibration module arranged to adjust the distortion applied by the control unit according to optical measurements carried out on at least one visual aid used by the user.

Accordingly, according to still another aspect of the present invention, there is provided a data processing system, wherein the calibration module is arranged to measure image characteristics of a plurality of predefined calibration images as viewed through the at least one visual aid and calibrate the control unit in relation to the measured image characteristics in respect to characteristics of the predefined calibration images.

Embodiments of the present invention provide a computer-implemented method of overcoming at least one vision impairment of a user, comprising: receiving a plurality of original images; distorting the original images in relation to the at least one vision impairment and predefined criteria, and displaying the distorted images, such that the user suffering from the at least one vision impairment perceives the distorted images as a healthy user would have perceived the original images.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a data processing system for overcoming at least one vision impairment of a user, according to some embodiments of the invention; and

FIG. 2 is a high level flowchart illustrating a computer-implemented method of overcoming at least one vision impairment of a user, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

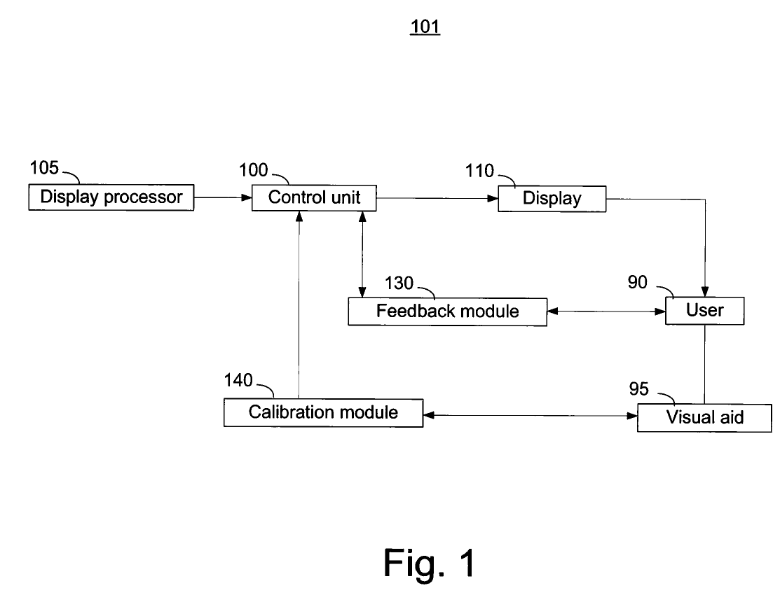

FIG. 1 is a high level schematic block diagram of a data processing system 101 for overcoming at least one vision impairment of a user 90, according to some embodiments of the invention. Data processing system 101 comprises a control unit 100 connected to a display 110. Control unit 100 is arranged to distort a plurality of original images from a display processor 105, a CPU, or a chipset within system 101 in relation to the vision impairments and predefined criteria, and to display the distorted images on display 110, such that user 90 (suffering from the vision impairments) perceives the distorted images as a healthy user would have perceived the original images, thus correcting for the vision impairments without the need to use vision aids.

According to some embodiments of the invention, the distortion is continuously and dynamically adjusted in relation to spatial and temporal dimensions of the original images or video streams and of objects therein. The distortion may be applied on the full screen or on a section of the original images, such as subtitles in a movie, allowing the user to read them more easily.

According to some embodiments of the invention, the vision impairment may comprise color blindness and the distortion may comprise adjusting colors in the original images such as to allow the user differentiate predefined colors in the original images.

According to some embodiments of the invention, the vision impairment may comprise astigmatism, and control unit 100 may be arranged to compensate for regular and for irregular defects.

According to some embodiments of the invention, the vision impairment may comprise myopia, and control unit 100 may be arranged to compensate for blurring of seemingly distant objects in the original images.

According to some embodiments of the invention, the vision impairment may comprise hyperopia or presbyopia, and control unit 100 may be arranged to allow user 90 to clearly perceive seemingly near objects in the original images, according to parameters related to the specific vision impairment.

According to some embodiments of the invention, display 110 may comprise a watch, a mobile device display, a phone handset, a screen of any type (e.g., a computer display, a monitor, a TV screen, a flexible display, a projected display), a transparent material, such as a window, or associated therewith (for example, a vehicle window, wherein data processing system 101 extends a field of view of user 90 driving the vehicle), or with a reflecting material such as a mirror. Vehicles may comprise cars, trains, airplanes etc.

According to some embodiments of the invention, control unit 100 may be further arranged to receive user defined characteristics of the vision impairments and distort the original images accordingly in relation thereto.

According to some embodiments of the invention, data processing system 101 may further comprise a feedback module 130 arranged to present user 90 with a plurality of predefined calibration images and receive from user 90 input relating to the perceived clarity of the predefined calibration images. Feedback module 130 may be arranged to calculate at least one distortion parameter from user input and adjust the distortion applied by control unit 100 to the original images accordingly.

According to some embodiments of the invention, data processing system 101 may further comprise a calibration module 140 arranged to adjust the distortion applied by control unit 100 according to optical measurements carried out on at least one visual aid 95 used by user 90 such as glasses or contact lenses. Calibration module 140 may be arranged to measure image characteristics of a plurality of predefined calibration images as viewed through visual aid 95 and calibrate control unit 100 in relation to the measured image characteristics in respect to characteristics of the predefined calibration images.

According to some embodiments of the invention, data processing system 101 may be arranged to receive the original images directly from integral display processor 105, or CPU or via a communication link from an image source, and control unit 100 may be arranged to distort the received original images and display the distorted images on display 110 substantially immediately (in real-time) after their receipt.

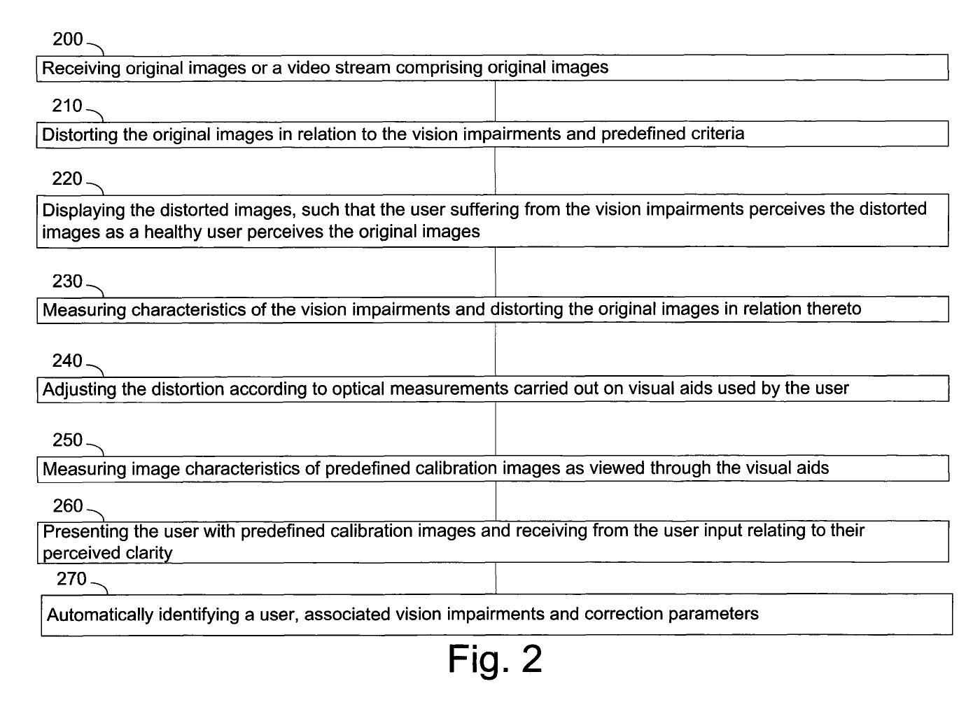

FIG. 2 is a high level flowchart illustrating a computer-implemented method of overcoming at least one vision impairment of a user, according to some embodiments of the invention. The computer-implemented method comprises the following stages: receiving a plurality of original images or video streams comprising original images (stage 200); distorting the original images in relation to the at least one vision impairment and predefined criteria (stage 210); and displaying the distorted images, such that the user suffering from the at least one vision impairment perceives the distorted images as a healthy user perceives the original images (stage 220). According to some embodiments of the invention, the computer-implemented method may further comprise measuring characteristics of the at least one vision impairment and distorting the original images in relation thereto (stage 230).

According to some embodiments of the invention, the computer-implemented method may further comprise adjusting the distortion according to optical measurements carried out on visual aids used by the user (stage 240).

According to some embodiments of the invention, the computer-implemented method may further comprise measuring image characteristics of predefined calibration images as viewed through the visual aids (stage 250).

According to some embodiments of the invention, the computer-implemented method may further comprise presenting the user with predefined calibration images and receiving from the user input relating to their perceived clarity (stage 260).

According to some embodiments of the invention, the computer-implemented method may further comprise automatically identifying a user, associated vision impairments and correction parameters (stage 270).

According to some embodiments of the invention, the computer-implemented method may be implemented by first identifying the user or measuring parameters of the visual aids, or by automatically identifying the user.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A data processing system for overcoming at least one vision impairment of a user, comprising a control unit connected to a display, wherein the control unit is arranged to distort a plurality of original images in relation to the at least one vision impairment and predefined criteria, and to display the distorted images on the display, such that the user suffering from the at least one vision impairment perceives the distorted images as a healthy user perceives the original images.

2. The data processing system of claim 1, wherein the distortion is continuously and dynamically adjusted in relation to spatial and temporal dimensions of the original images and of objects therein.

3. The data processing system of claim 1, wherein the distortion is carried out on a section of the original images.

4. The data processing system of claim 1, wherein the at least one vision impairment comprises color blindness and wherein the distortion comprises adjusting colors in the original images such as to allow the user differentiate predefined colors in the original images.

5. The data processing system of claim 1, wherein the at least one vision impairment comprises astigmatism, and the control unit is arranged to compensate for regular and for irregular defects.

6. The data processing system of claim 1, wherein the at least one vision impairment comprises myopia, and the control unit is arranged to compensate for blurring of seemingly distant objects in the original images.

7. The data processing system of claim 1, wherein the at least one vision impairment comprises hyperopia, and the control unit is arranged to allow the user to clearly perceive seemingly near objects in the original images.

8. The data processing system of claim 1, wherein the at least one vision impairment comprises presbyopia, and the control unit is arranged to allow the user to clearly perceive seemingly near objects in the original images.

9. The data processing system of claim 1, wherein the display is a mobile device display.

10. The data processing system of claim 1, wherein the display is a screen.

11. The data processing system of claim 1, wherein the display is associated with a transparent material.

12. The data processing system of claim 11, wherein the display is associated with a vehicle window, and wherein the data processing system extends a field of view of the user driving the vehicle.

13. The data processing system of claim 1, wherein the display is associated with a reflecting material.

14. The data processing system of claim 1, wherein the control unit is further arranged to receive user defined characteristics of the at least one vision impairment.

15. The data processing system of claim 1, further comprising a feedback module arranged to present the user with a plurality of predefined calibration images and receive from the user input relating to the perceived clarity of the predefined calibration images, wherein the feedback module is arranged to calculate at least one distortion parameter from user input and adjust the distortion applied by the control unit to the original images accordingly.

16. The data processing system of claim 1, further comprising a calibration module arranged to adjust the distortion applied by the control unit according to optical measurements carried out on at least one visual aid used by the user.

17. The data processing system of claim 16, wherein the calibration module is arranged to measure image characteristics of a plurality of predefined calibration images as viewed through the at least one visual aid and calibrate the control unit in relation to the measured image characteristics in respect to characteristics of the predefined calibration images.

18. The data processing system of claim 1, wherein the data processing system is arranged to receive the original images from a display processor, and wherein the control unit is arranged to distort the received original images and display the distorted images on the display substantially immediately after their receipt.

19. A computer-implemented method of overcoming at least one vision impairment of a user, comprising:
receiving a plurality of original images;
distorting the original images in relation to the at least one vision impairment and predefined criteria, and
displaying the distorted images, such that the user suffering from the at least one vision impairment perceives the distorted images as a healthy user perceives the original images.

20. The computer-implemented method of claim 19, further comprising measuring characteristics of the at least one vision impairment and distorting the original images in relation thereto.
